(19) United States
(12) Patent Application Publication
(10) Pub. No.: US 2023/0351029 A1
(43) Pub. Date: Nov. 2, 2023

(54) INFORMATION PROCESSING APPARATUS, CONTROL METHOD FOR THE SAME, AND STORAGE MEDIUM

(71) Applicant: CANON KABUSHIKI KAISHA, Tokyo (JP)

(72) Inventor: Yoshiharu Ito, Kanagawa (JP)

(21) Appl. No.: 18/299,602

(22) Filed: Apr. 12, 2023

(30) Foreign Application Priority Data
Apr. 27, 2022 (JP) 2022-073364

(51) Int. Cl. G06F 21/60; H04L 9/30; G06F 21/64

(52) U.S. Cl. CPC G06F 21/602; H04L 9/30; G06F 21/64

(57) ABSTRACT

An information processing apparatus that includes at least a non-transitory computer-readable storage medium storing a program and at least a processor configured to execute the program to perform a method of managing a plurality of pieces of authenticity confirmation information used to confirm authenticity of data, managing validity information indicating whether each of the plurality of pieces of authenticity confirmation information is valid, and confirming the authenticity of the data using the authenticity confirmation information to be indicated as valid with the validity information, wherein in a case where the authenticity of the data is confirmed using second authenticity confirmation information that is different from first authenticity confirmation information and is indicated as valid with the validity information in response to an instruction for invalidating the first authenticity confirmation information, update the validity information associated with the first authenticity confirmation information.

### BACKGROUND

### Field

The present disclosure relates to an information processing apparatus, a control method for the information processing apparatus, and a storage medium.

### Description of the Related Art

In order to ensure security in an information processing apparatus, it is important to confirm in advance the authenticity of software to be operated in the information processing apparatus and to operate the software after it is determined to be valid. Operating the software without confirming its authenticity means allowing operating software of which the creator is unknown.

Under the circumstances, for example, information in the information processing apparatus could be leaked to the outside, and an outsider could invade the information processing apparatus due to an operation of software created by a malicious creator.

A digital signature technique combining public key cryptography and a cryptographic hash description is widely used to confirm the authenticity of software. On the other hand, even with such a technique in use, if a secret key in the public key cryptography is leaked for some reasons, a third party who obtains the secret key can pretend to be a legitimate creator and operate unauthorized software. Against this background, Japanese Patent Application Laid-Open No. 2008-226160 discusses a method for starting up software after confirming its authenticity using a value that is uniquely determined from data about the software when the leakage of a secret key is found, or when a public key expires due to passing of an expiration date.

On the other hand, the method for confirming the authenticity using the value uniquely determined from data about the software tends to be less resistant to analysis than a method using a digital signature technique, which can result in a greater likelihood that a third party can pretend to be a legitimate creator and operate unauthorized software. Against this background, in invalidating information used to confirm the authenticity of data, such as a public key, there is a demand for implementation of a mechanism that can both ensure security against unauthorized use by a malicious third party and prevent a decline in convenience due to invalidation of the information.

### SUMMARY

In view of the above-described issues, the present disclosure is directed to implementation of update of the validity of information used to confirm the authenticity of data in a more suitable manner.

According to an aspect of the present disclosure, an information processing apparatus that includes at least a non-transitory computer-readable storage medium storing a program and at least a processor configured to execute the program to perform a method of managing a plurality of pieces of authenticity confirmation information used to confirm authenticity of data, managing validity information indicating whether each of the plurality of pieces of authenticity confirmation information is valid, and confirming the authenticity of the data using the authenticity confirmation information to be indicated as valid with the validity information, wherein in a case where the authenticity of the data is confirmed using second authenticity confirmation information that is different from first authenticity confirmation information and is indicated as valid with the validity information in response to an instruction for invalidating the first authenticity confirmation information, update the validity information associated with the first authenticity confirmation information.

Further features of the present disclosure will become apparent from the following description of exemplary embodiments with reference to the attached drawings.

### BRIEF DESCRIPTION OF THE DRAWINGS

FIG. 1 illustrates an example of the hardware configuration of an information processing apparatus.

FIGS. 2A to 2D illustrate examples of data used to verify the authenticity of an executable code.

FIG. 3 is a flowchart illustrating an example of processing by the information processing apparatus.

FIG. 4 is a flowchart illustrating an example of processing by the information processing apparatus.

### DESCRIPTION OF THE EMBODIMENTS

Exemplary embodiments of the present disclosure will be described in detail below with reference to the attached drawings.

In the present specification and drawings, like numbers refer to like components having substantially the same functional configuration, and redundant descriptions will be omitted.

### Hardware Configuration

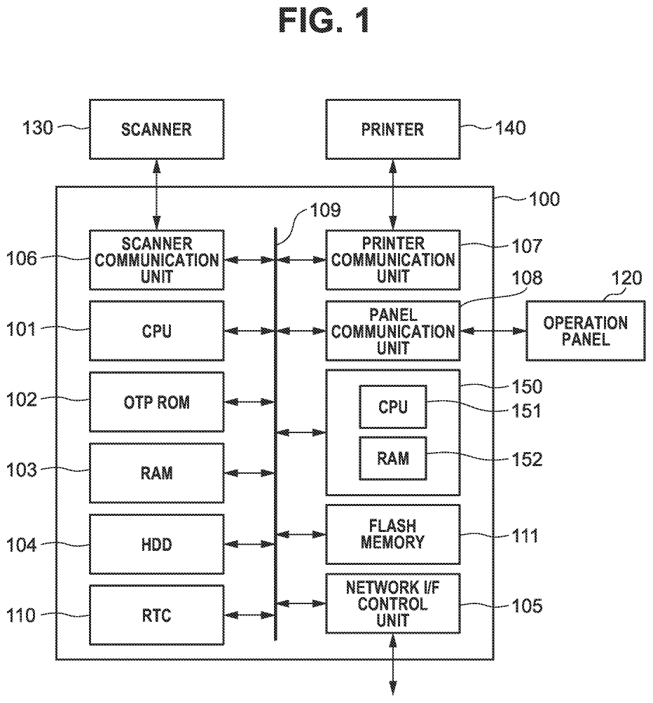

An example of the hardware configuration of a multifunction peripheral 100 as an example of an information processing apparatus to which a technique according to an exemplary embodiment of the present disclosure is applied and a controller (embedded controller (EC)) 150 incorporated into the multifunction peripheral 100 will be described with reference to FIG. 1.

A central processing unit (CPU) 101 controls general operations of the multifunction peripheral 100 by running software programs for the multifunction peripheral 100.

A one time programmable read only memory (OTPROM) 102 is a storage area that can be written only once. Data stored in the OTPROM 102 is restricted from being erased or updated. The OTPROM 102 stores a basic input output system (BIOS) of and information, such as fixed parameters, about the multifunction peripheral 100.

A random access memory (RAM) 103 is used as a storage area for storing programs and temporary data when the CPU 101 controls operations of the multifunction peripheral 100.

A hard disk drive (HDD) 104 serves as an auxiliary storage device for storing application programs and various types of data. A nonvolatile memory represented by a solid state drive (SSD) may be used instead of or together with the HDD 104.

A flash memory 111 is a storage area for storing various types of programs and data.

The flash memory 111 stores programs, such as a loader, a kernel, and an application.

The controller 150 includes a CPU 151 and a RAM 152.

The CPU 151 runs software programs for the controller 150 and partially controls operations of the multifunction peripheral 100.

The RAM 152 is used as a storage area for storing programs and temporary data when the CPU 151 partially controls operations of the multifunction peripheral 100.

A real time clock (RTC) 110 is implemented by a real time clock module and stores information indicating a current time.

A network interface (I/F) control unit 105 controls transmission and reception of data between the multifunction peripheral 100 and an external apparatus via a network (not illustrated).

A scanner communication unit 106 controls the operation of a scanner 130, such as reading documents.

A printer communication unit 107 controls the operation of a printer 140, such as document print processing.

A panel communication unit 108 communicates with an operation panel 120. The operation panel 120 displays various types of information related to the multifunction peripheral 100, receives instructions from users, and notifies the multifunction peripheral 100 of the information indicating the instructions.

A bus 109 connects the CPU 101, the OTPROM 102, the RAM 103, the HDD 104, the network I/F control unit 105, the scanner communication unit 106, the printer communication unit 107, the RTC 110, and the flash memory 111 to one another. The bus 109 further connects the panel communication unit 108, the controller 150, and the flash memory 111 to one another. Transmission of control signals from the CPU 101 and transmission and reception of data signals between each component are performed through the bus 109.

The configuration illustrated in FIG. 1 is merely an example and does not limit the hardware configuration of the multifunction peripheral 100 according to the present exemplary embodiment. As a specific example, a component may be added as appropriate according to a function implemented by the multifunction peripheral 100.

### Schematic Configuration of Data

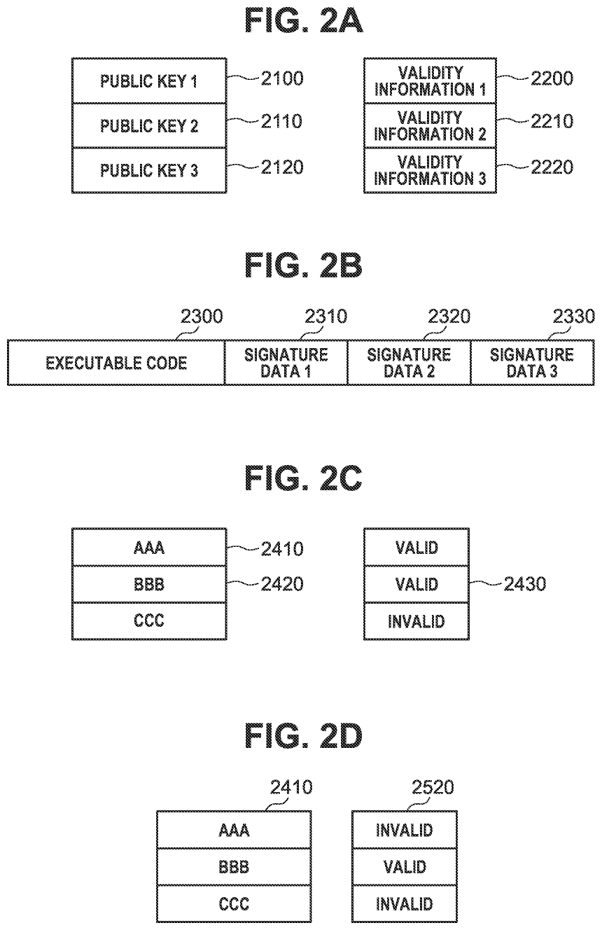

An example of data used to verify the authenticity of an executable code will be described with reference to FIGS. 2A to 2D. Details of FIGS. 2A and 2B will be described here, and details of FIGS. 2C and 2D will be described separately below.

First, individual examples of information used to confirm the authenticity of data and information indicating the validity of the information will now be described with reference to FIG. 2A.

A first public key 2100, a second public key 2110, and a third public key 2120 are each an example of information used to confirm the authenticity of data and can be used as a public key used in, for example, a public key cryptosystem. In other words, a plurality of public keys is managed as information used to confirm the authenticity of data in the example illustrated in FIG. 2A. These public keys are examples of “authenticity confirmation information” used to confirm the authenticity of data.

First validity information 2200, second validity information 2210, and third validity information 2220 respectively correspond to pieces of validity information indicating the validity (valid or revoked) of the first public key 2100, the second public key 2110, and the third public key 2120. The first validity information 2200, the second validity information 2210, and the third validity information 2220 are each set with information indicating that it is valid as an initial value. A series of the above-described pieces of information illustrated in FIG. 2A are managed by being stored as data in the OTPROM 102, for example.

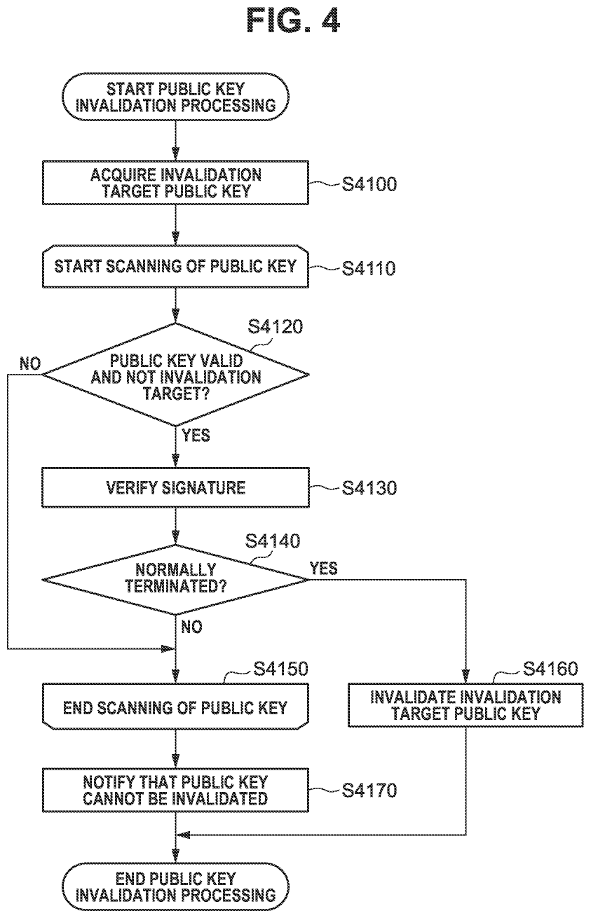

Next, an example of data to be an authenticity confirmation target will now be described with reference to FIG. 2B. The data illustrated in FIG. 2B schematically illustrates a code of a program to be run by the CPU 101 (hereinbelow also referred to as an executable code). In the example illustrated in FIG. 2B, first signature data 2310, second signature data 2320, and third signature data 2330 are associated with an executable code 2300. The executable code 2300 is a code to be run by the CPU 101, and by running the code, for example, processing described below with reference to FIG. 4 is performed. The first signature data 2310, the second signature data 2320, and the third signature data 2330 each corresponds to signature data in an electronic signature technique applying the public key cryptosystem. These pieces of signature data are generated based on the executable code 2300 and secret keys (not illustrated) corresponding to the first public key 2100, the second public key 2110, and the third public key 2120 illustrated in FIG. 2A. The data illustrated in FIG. 2B as the example is stored, for example, in the HDD 104.

### Processing

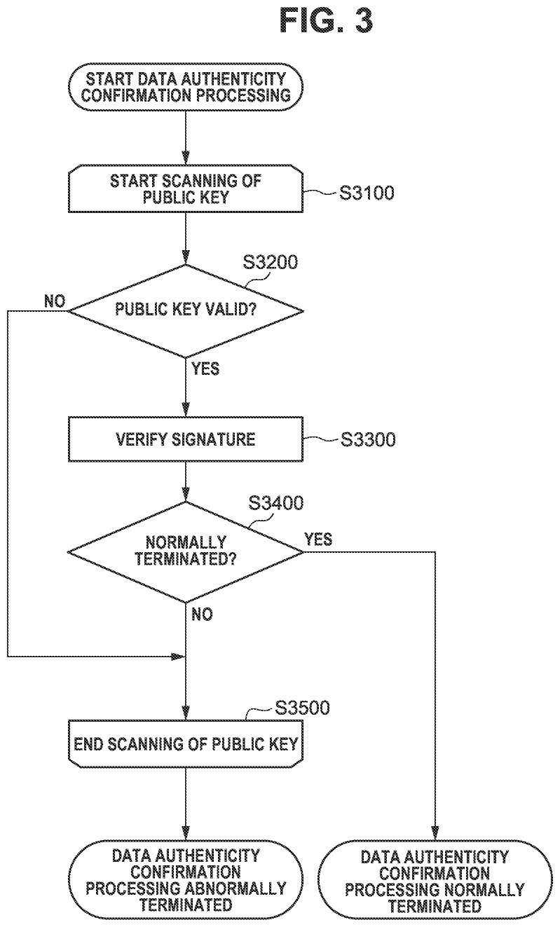

Examples of processing by the information processing apparatus according to the present exemplary embodiment will now be described with reference to FIGS. 3 and 4. In the examples illustrated in FIGS. 3 and 4, the multifunction peripheral 100 described with reference to FIG. 1 is used as the information processing apparatus according to the present exemplary embodiment.

First, an example of processing for confirming the authenticity of data will now be described with reference to FIG. 3. In the example illustrated in FIG. 3, a public key used in the public key cryptosystem is used to confirm the authenticity of data as a target, and the first public key 2100, the second public key 2110, and the third public key 2120 illustrated in FIG. 2A can be used as the public key. In addition, the processing illustrated in FIG. 3 is carried out by the CPU 101 running software stored in the OTPROM 102. For this reason, electrical erasing and rewriting of the software are restricted.

The CPU 101 sequentially reads the first public key 2100, the second public key 2110, and the third public key 2120 while scanning them, and performs processing in steps S3100 to S3500 for the read public key as the target. In this manner, the CPU 101 repeatedly performs the processing in steps S3100 to S3500 until a termination condition for repeated run is satisfied.

The processing in steps S3100 to S3500 will be described in more detail.

In step S3200, the CPU 101 determines whether a public key read as a processing target is valid based on validity information corresponding to the public key. As a specific example, when the validity of the first public key 2100 is determined, the CPU 101 refers to the first validity information 2200 and determines that the first public key 2100 is valid if the valid information is stored. Similarly, the CPU 101 refers to the second validity information 2210 when determining the validity of the second public key 2110, and refers to the third validity information 2220 when determining the validity of the third public key 2120.

If it is determined that the public key read as the processing target is valid (YES in step S3200), the CPU 101 advances the processing to step S3300.

On the other hand, if it is determined that the public key read as the processing target is not valid (NO in step S3200), the CPU 101 advances the processing to step S3500. In this case, the CPU 101 reads a public key that has not yet been processed as the processing target, and performs the processing in step S3200 and subsequent steps again for the read public key as the target.

In step S3300, the CPU 101 performs signature verification processing using the public key confirmed as valid in step S3200 and the signature data associated with the data as the authenticity confirmation target. As described above, according to the present exemplary embodiment, the electronic signature technique applying the public key cryptosystem is used to confirm the authenticity of data. A known technique can be applied to the signature verification processing in this case, and thus the detailed description thereof is omitted.

In the processing in step S3300, the number of pieces of signature data to be subjected to the signature verification processing by the CPU 101 is not particularly limited.

For example, the CPU 101 may perform signature verification processing for signature data associated with a public key extracted as a processing target. Specifically, with the first public key 2100 illustrated in FIG. 2A associated with the first signature data 2310 illustrated in FIG. 2B, the CPU 101 may perform the signature verification processing for the first signature data 2310 as the target.

In addition, the order of a series of pieces of signature data associated with the executable code 2300 may not be specified, and the number of public keys managed may not match the number of pieces of the signature data associated with the executable code 2300. Thus, for example, the CPU 101 may perform the signature verification processing for each piece of signature data associated with the executable code 2300, as well as for the signature data associated with the public key extracted as the processing target. Specifically, even if the first public key 2100 illustrated in FIG. 2A is extracted as the processing target, the CPU 101 may perform the signature verification processing for the first signature data 2310, the second signature data 2320, and the third signature data 2330.

In step S3400, the CPU 101 determines whether the signature verification processing performed in step S3300 is normally terminated. The normal termination of the signature verification processing means that the data as the authenticity confirmation target (for example, the executable code 2300 illustrated in FIG. 2B) is intended data (unaltered data).

If it is determined that the signature verification processing is normally terminated (YES in step S3400), the CPU 101 terminates the series of processing illustrated in FIG. 3 determining that the confirmation result of the authenticity of data is normal.

On the other hand, if it is determined that the signature verification processing is abnormally terminated (NO in step S3400), the CPU 101 advances the processing to step S3500. In this case, the CPU 101 reads a public key that has not yet been processed as the processing target, and performs the processing in step S3200 and subsequent steps again for the read public key as the target.

The CPU 101 performs the processing in steps S3100 to S3500 up to the number of the public keys as scanning targets. In other words, in the case of the example illustrated in FIG. 2A, the processing in steps S3100 to S3500 is performed three times in total, once for each of the public keys, the first public key 2100, the second public key 2110, and the third public key 2120. Then, if the signature verification processing is not terminated normally for any of the public keys as the scanning targets, the CPU 101 terminates the series of processing illustrated in FIG. 3 determining that the confirmation result of the authenticity of data is abnormal.

Subsequent operations after the processing illustrated in FIG. 3 is abnormally terminated may be appropriately prescribed according to the use case. As a specific example, the startup processing of a target apparatus (for example, the multifunction peripheral 100) may be restricted in view of a possibility that the executable code 2300 is rewritten to an executable code different from what is originally intended. As a specific example, the processing illustrated in FIG. 3 is performed in parallel with the startup processing of the target apparatus, and if the processing illustrated in FIG. 3 is abnormally terminated, the startup processing of the target apparatus may be stopped (interrupted). As another example, if the processing illustrated in FIG. 3 is abnormally terminated, the target apparatus may be started in a state in which the use of an extended function, such as a function of accessing the outside via the network, is restricted, such as starting up in a safe mode.

Next, an example of processing performed by the CPU 101 when the multifunction peripheral 100 according to the present exemplary embodiment receives a revocation instruction for the public key will be described with reference to FIG. 4. In the example illustrated in FIG. 4, the first public key 2100, the second public key 2110, and the third public key 2120 illustrated in FIG. 2A can be used as the public keys. Further, the processing illustrated in FIG. 4 is carried out by the CPU 101 loading software stored in one or both of the HDD 104 and the flash memory 111 in the RAM 103 and running it.

In step S4100, the CPU 101 acquires information about the public key as a target for invalidation processing (that is, the public key for which a revocation instruction is issued). Then, the CPU 101 sequentially reads the first public key 2100, the second public key 2110, and the third public key 2120 while scanning them, and performs processing in steps S4110 to S4150 for the read public key as the target. In this manner, the CPU 101 repeatedly performs the processing in steps S4110 to S4150 until a termination condition for repeated run is satisfied.

The processing in steps S4110 to S4150 will be described in more detail.

In step S4120, the CPU 101 determines whether the public key read as the processing target is valid based on the validity information corresponding to the read public key, and further confirms that the public key is not the one specified as the invalidation target. As a specific example, when the validity of the first public key 2100 is determined, the CPU 101 refers to the first validity information 2200 and determines that the first public key 2100 is valid if the valid information is stored. Similarly, the CPU 101 refers to the second validity information 2210 when determining the validity of the second public key 2110, and refers to the third validity information 2220 when determining the validity of the third public key 2120. Further, the CPU 101 determines whether the public key of which the validity is to be determined matches the public key (that is, the public key specified as the invalidation target) of which the information is acquired in step S4100.

If it is determined that the public key read as the processing target is valid and does not match the public key specified as the invalidation target (YES in step S4120), the CPU 101 advances the processing to step S4130.

On the other hand, if it is determined that the public key read as the processing target is not valid or matches the public key specified as the invalidation target (NO in step S4120), the CPU 101 advances the processing to step 54150. In this case, the CPU 101 reads a public key that has not yet been processed as the processing target, and performs the processing in step S4120 and subsequent steps again for the read public key as the target.

In step S4130, the CPU 101 performs the signature verification processing using the public key that is confirmed to be valid and is not the invalidation target in step S4120 and the signature data paired with the public key. As described above, according to the present exemplary embodiment, the electronic signature technique applying the public key cryptosystem is used to confirm the authenticity of data. A known technique can be applied to the signature verification processing in this case, and thus the detailed description thereof is omitted.

In the processing in step S4130, the number of pieces of signature data to be subjected to the signature verification processing by the CPU 101 is not particularly limited.

For example, the CPU 101 may perform the signature verification processing for the signature data associated with the public key extracted as the processing target. Specifically, if the first public key 2100 illustrated in FIG. 2A is associated with the first signature data 2310 illustrated in FIG. 2B, the CPU 101 may perform the signature verification processing for the first signature data 2310 as the target.

In addition, the order of the series of signature data associated with the executable code 2300 may not be specified, and the number of public keys managed may not match the number of pieces of the signature data associated with the executable code 2300. Thus, for example, the CPU 101 may perform the signature verification processing for each piece of signature data associated with the executable code 2300, as well as for the public key extracted as the processing target. Specifically, even if the first public key 2100 illustrated in FIG. 2A is extracted as the processing target, the CPU 101 may perform the signature verification processing for the first signature data 2310, the second signature data 2320, and the third signature data 2330.

In step S4140, the CPU 101 determines whether the signature verification processing performed in step S4130 is normally terminated. The normal termination of the signature verification processing means that the authenticity of the target data (for example, the executable code 2300 illustrated in FIG. 2B) can be verified even if the public key specified as the target of the invalidation processing in step S4100 is actually invalidated.

Thus, if it is determined that the signature verification processing is normally terminated (YES in step S4140), the CPU 101 advances the processing to step S4160. In step S4160, the CPU 101 performs the invalidation processing for the public key specified as the invalidation target in step S4100. As a specific example, information indicating a revoked state is written to the validity information illustrated in FIG. 2A, and thus the public key associated with the validity information is invalidated.

A specific example of the invalidation processing for the public key illustrated as the processing in step S4160 will be described with reference to FIGS. 2C and 2D. FIG. 2C illustrates an example of a state of each of the public keys and validity information before the revocation instruction is received. In the example illustrated in FIG. 2C, public keys 2410 and 2420 are each in a valid state. Then, it is assumed that a revocation instruction specifying the public key 2410 is received.

In this case, the CPU 101 performs the signature verification processing for the public key 2420 as the target, which is different from the public key 2410 to be the invalidation target and of which validity information 2430 is valid. Then, when the signature verification processing for the public key 2420 is normally terminated, the CPU 101 performs the invalidation processing for the public key 2410, which is the invalidation target.

FIG. 2D illustrates an example of a state of each of the public keys and validity information after the invalidation processing for the public key 2410 is performed in the example illustrated in FIG. 2C. As illustrated in FIG. 2D, information indicating invalidity is written in validity information 2520 corresponding to the public key 2410, and thus the public key 2410 is invalidated.

A result of invalidating the public key by the processing in step S4160 is reflected in, for example, the processing in step S3200 illustrated in FIG. 3 and the processing in step S4120 illustrated in FIG. 4. As a specific example, when the processing in step S4160 results in the state illustrated in FIG. 2D, the public key 2410 is determined to be in the revoked state in the processing in step S3200 illustrated in FIG. 3 in turning on and starting up the MFP 100 again. In other words, in this case, the public key 2410 is excluded from the target of the signature verification processing illustrated as the processing in step S3300 in FIG. 3.

The above-described control allows invalidation of the public key 2410 even if the secret key corresponding to the public key 2410 is leaked, preventing an unintended executable code from being run.

Referring back to FIG. 4, in step S4140, if it is determined that the signature verification processing is abnormally terminated (NO in step S4140), the CPU 101 advances the processing to step S4150. In this case, the CPU 101 reads a public key that has not yet been processed as the processing target, and performs the processing in step S4120 and subsequent steps again for the read public key as the target.

The CPU 101 performs the processing in steps S4110 to S4150 up to the number of the public keys as scanning targets. In other words, in the case of the example illustrated in FIG. 2A, the processing in steps S4110 to S4150 is performed three times in total, once for each of the public keys, the first public key 2100, the second public key 2110, and the third public key 2120. Then, the signature verification processing illustrated as the processing in step S4130 is performed for a public key that is valid and not specified as the invalidation target among the first public key 2100, the second public key 2110, and the third public key 2120.

If the signature verification processing is not terminated normally for any of the public keys that are valid and not specified as the invalidation target, the CPU 101 advances the processing to step S4170. In this case, the invalidation of the specified public key means that the signature verification processing for the target data (for example, the executable code 2300 illustrated in FIG. 2B) will not be normally terminated. Thus, in step S4170, the CPU 101 notifies a predetermined notification destination of information indicating that the public key cannot be invalidated.

The notification destination and a notification method for the information indicating that the public key cannot be invalidated may be changed as appropriate according to the use case.

For example, the CPU 101 may notify a notification source of a revocation instruction for a public key of the information indicating that the public key cannot be invalidated as a response to the revocation instruction. At this time, the CPU 101 may determine a method for notifying the notification source of the revocation instruction of the information indicating that the public key cannot be invalidated depending on the way of the revocation instruction for the public key being notified.

As a specific example, when the revocation instruction for the public key is notified from another control apparatus via the network, the CPU 101 may access the network and notify the other control apparatus of the information indicating that the public key cannot be invalidated.

As another example, the CPU 101 may display the information indicating that the public key cannot be invalidated on a predetermined display unit, such as a screen of the operation panel 120, via the panel communication unit 108 to notify a user of the information.

The above-described notification, for example, allows a user or an administrator of the information processing apparatus, such as the multifunction peripheral 100, to recognize that a public key for which a revocation instruction is issued cannot be invalidated. This, for example, enables the user or the administrator to take measures, such as updating the software (for example, updating the executable code and the signature data) of the target information processing apparatus. Further, by taking such measures, it can be expected that invalidation processing for a public key is normally terminated if the revocation instruction for the public key is issued again.

As another example, the above-described notification made to the other control apparatus that issues a revocation instruction for a public key makes it possible to cause the other control apparatus to perform other processing using the notification as a trigger. This, for example, enables control that causes the above-described other control apparatus to instruct the target information processing apparatus to update the software (for example, updating the executable code and the signature data) using the above-described notification as a trigger.

The above-described control allows confirmation of the authenticity of data by signature verification processing using another public key in a valid state even if some secret keys are leaked or a public key expires due to passing of its expiration date. Further, even if a revocation instruction is issued for a public key, the signature verification processing performed in advance using another public key in a valid state prevents an apparatus from failing to be started while the public key for which the revocation instruction is issued is invalidated.

### Other Exemplary Embodiment

The present disclosure can also be implemented by performing processing that a program for carrying out one or more functions of the above-described exemplary embodiments is supplied to a system or an apparatus via a network or a storage medium, and one or more processors in a computer of the system or the apparatus read and run the program. The present disclosure can also be implemented by a circuit (for example, an application specific integrated circuit (ASIC)) for carrying out one or more functions.

The above-described exemplary embodiments are merely examples and are not intended to limit the present disclosure. Further, not all combinations of features described above in the exemplary embodiments are used as solving means of the present disclosure. In other words, various modifications can be made without departing from the spirit and the scope of the present disclosure.

For example, when the information indicating that the public key cannot be invalidated is notified in step S4170 illustrated in FIG. 4, the information indicating that the public key cannot be invalidated may be stored in a temporary information storage area (not illustrated) and used in the next startup.

As a specific example, the CPU 101 may refer to the above-described information stored in the temporary information storage area before performing the processing in step S3100 illustrated in FIG. 3 in the next startup, and cause the processing to branch to other processing different from the processing illustrated in FIG. 3, causing the multifunction peripheral 100 to shift to a specific operation state. Examples of the specific operation state include a state in which the execution of the processing other than updating the firmware is restricted. The shift to the above-described state also enables the multifunction peripheral 100 to be guided to the processing of updating the executable code 2300 and the pieces of signature data 2310 to 2330 as illustrated in FIG. 2B.

Thus, with the executable code 2300 and the signature data 2310 to 2330 updated, it can be expected that invalidation processing for a public key is normally terminated if the revocation instruction for the public key is issued again. Further, with the multifunction peripheral 100 shifted to the specific state, the effect of preventing an unintended executable code from being run can be also expected.

Further, applications of the technique according to the present disclosure are not limited to the examples described above as the exemplary embodiments, and the techniques according to the present disclosure can be applied under the circumstances where authenticity confirmation information, such as a public key, is used to confirm the authenticity of data.

As a specific example, data to be an authenticity confirmation target using authenticity confirmation information is not limited to an executable code of firmware, but an executable code of an application may be applied as a target. Further, along with executable codes of firmware and an application, data and the like to be used by these programs to perform various types of processing may be subject to authenticity confirmation. In addition, if data, such as documents, as well as data to be used by programs to perform various types of processing, is subject to authenticity confirmation using authenticity confirmation information, these types of data can be subject to the techniques according to the present disclosure.

According to the above-described exemplary embodiments, the example is described in which authenticity confirmation information, such as a public key, is managed by being stored in a storage area (for example, the OTPROM 102) provided in an information processing apparatus, such as the multifunction peripheral 100. On the other hand, as long as the CPU 101 can refer to the above-described authenticity confirmation information in confirming the authenticity of data as the target, a management method for the authenticity confirmation information is not particularly limited. As a specific example, the authenticity confirmation information may be managed by an external apparatus. In this case, the CPU 101 can acquire the authenticity confirmation information used to confirm the authenticity of the data as the target by accessing the external apparatus via a predetermined network. Further, as with the authenticity confirmation information, a management method for validity information indicating the validity of the authenticity confirmation information is not also particularly limited.

According to the above-described exemplary embodiments, the descriptions focus on the case where a public key is used as authenticity confirmation information on the assumption that the public key cryptography is used to confirm the authenticity of data as the target, but it does not necessarily limit the applications of the techniques according to the present disclosure. In other words, the techniques according to the present disclosure can be applied even in a situation where other information different from a public key exemplified above is used as authenticity confirmation information.

According to the above-described exemplary embodiments, the update of validity of information used to confirm the authenticity of data can be performed in a more suitable manner.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-073364, filed Apr. 27, 2022, which is hereby incorporated by reference herein in its entirety.

What is claimed is:

1. An information processing apparatus comprising:
at least a non-transitory computer-readable storage medium storing a program; and
at least a processor configured to execute the program to perform a method comprising:
managing a plurality of pieces of authenticity confirmation information used to confirm authenticity of data;
managing validity information indicating whether each of the plurality of pieces of authenticity confirmation information is valid; and
confirming the authenticity of the data using the authenticity confirmation information to be indicated as valid with the validity information,
wherein in a case where the authenticity of the data is confirmed using second authenticity confirmation information that is different from first authenticity confirmation information and is indicated as valid with the validity information in response to an instruction for invalidating the first authenticity confirmation information, update the validity information associated with the first authenticity confirmation information.

2. The information processing apparatus according to claim 1, wherein the authenticity of the data confirms in parallel with startup processing for the information processing apparatus and restricts the startup processing in a case where the authenticity of the data cannot be confirmed.

3. The information processing apparatus according to claim 2, wherein the startup processing stops in a case where the authenticity of the data cannot be confirmed.

4. The information processing apparatus according to claim 1, wherein the authenticity confirmation information is stored in a storage area that can be written only once.

5. The information processing apparatus according to claim 1, wherein the validity information is stored by storing the validity information in a storage area that can be written only once.

6. The information processing apparatus according to claim 1, wherein the authenticity confirmation information is restricted from being updated by being stored in a storage area where erasing and writing of data are restricted.

7. The information processing apparatus according to claim 1, wherein, in a case where the authenticity of the data cannot be confirmed using the second authenticity confirmation information, the validity information is not updated for invalidating the first authenticity confirmation information and a predetermined notification destination of information is notified for indicating that the first authenticity confirmation information cannot be invalidated as a response to the instruction for invalidating the first authenticity confirmation information.

8. The information processing apparatus according to claim 7, further comprises displaying information indicating that the first authenticity confirmation information cannot be invalidated as a response to the instruction for invalidating the first authenticity confirmation information to notify a user of the information.

9. The information processing apparatus according to claim 1, wherein, in a case where the authenticity of the data cannot be confirmed using the second authenticity confirmation information, an operation state of the information processing apparatus is shifted to a predetermined state.

10. The information processing apparatus according to claim 9, wherein the predetermined state is a state in which execution of processing other than processing related to updating target data is restricted.

11. The information processing apparatus according to claim 1, wherein, in a case where the authenticity of the data is confirmed using the second authenticity confirmation information, updating the validity information associated with the first authenticity confirmation information so that the first authenticity confirmation information is invalidated.

12. A method for controlling an information processing apparatus, the method comprising:
managing a plurality of pieces of authenticity confirmation information used to confirm authenticity of data;
managing validity information indicating whether each of the plurality of pieces of authenticity confirmation information is valid; and
confirming the authenticity of the data using the authenticity confirmation information to be indicated as valid with the validity information,
wherein in a case where the authenticity of the data is confirmed using second authenticity confirmation information that is different from first authenticity confirmation information and is indicated as valid with the validity information in response to an instruction for invalidating the first authenticity confirmation information, updating the validity information associated with the first authenticity confirmation information.

13. A storage medium storing a program for causing a computer to execute the program to carry out a method to function as an information processing apparatus, the method comprising:
managing a plurality of pieces of authenticity confirmation information used to confirm authenticity of data;
managing validity information indicating whether each of the plurality of pieces of authenticity confirmation information is valid; and
confirming the authenticity of the data using the authenticity confirmation information to be indicated as valid with the validity information,
wherein in a case where the authenticity of the data is confirmed using second authenticity confirmation information that is different from first authenticity confirmation information and is indicated as valid with the validity information in response to an instruction for invalidating the first authenticity confirmation information, update the validity information associated with the first authenticity confirmation information.

14. The storage medium according to claim 13, wherein the authenticity of the data confirms in parallel with startup processing for the information processing apparatus and restricts the startup processing in a case where the authenticity of the data cannot be confirmed.

15. The storage medium according to claim 14, wherein the startup processing stops in a case where the authenticity of the data cannot be confirmed.

16. The storage medium according to claim 13, wherein the authenticity confirmation information is stored in a storage area that can be written only once.

17. The storage medium according to claim 13, wherein the validity information is stored in a storage area that can be written only once.

18. The storage medium according to claim 13, wherein the authenticity confirmation information is restricted from being updated by being stored in a storage area where erasing and writing of data are restricted.

19. The storage medium according to claim 13, wherein, in a case where the authenticity of the data cannot be confirmed using the second authenticity confirmation information, the validity information is not updated for invalidating the first authenticity confirmation information and a predetermined notification destination of information is notified for indicating that the first authenticity confirmation information cannot be invalidated as a response to the instruction for invalidating the first authenticity confirmation information.

20. The storage medium according to claim 13, wherein, in a case where the authenticity of the data cannot be confirmed using the second authenticity confirmation information, an operation state of the information processing apparatus is shifted to a predetermined state.
